(19) United States
(12) Patent Application Publication
(10) Pub. No.: US 2011/0246688 A1
(43) Pub. Date: Oct. 6, 2011

(54) MEMORY ARBITRATION TO ENSURE LOW LATENCY FOR HIGH PRIORITY MEMORY REQUESTS

(76) Inventors: IRWIN VAZ, Milpitas, CA (US); ROHIT NATARAJAN, Sunnyvale, CA (US); ALOK MATHUR, Cupertino, CA (US); SURI MEDAPATI, San Jose, CA (US)

(21) Appl. No.: 12/752,986

(22) Filed: Apr. 1, 2010

(51) Int. Cl. G06F 3/00; G06F 13/14

(52) U.S. Cl. 710/54; 710/244; 711/169

(57) ABSTRACT

Embodiments of the invention describe arbitrating requests received from a plurality of agents for memory. Each memory request may indicate a priority level of the memory request and a size of the memory to be accessed. Said requests may be stored in a queue. Arbitration logic, coupled to the plurality of agents and the queue, may receive said memory requests and determine which requests to send to the queue based, at least in part, on the priority of each request and the size of the memory to be accessed by each memory request.

### FIELD

Embodiments of the invention generally pertain to system memory controllers, and more particularly to memory arbitration of agent requests for system memory.

### BACKGROUND

Computer systems often utilize a memory controller to control access to a memory by a processor and other system components (i.e., “agents”). Agents may access portions of a memory by issuing requests to the memory controller.

In some computer systems, the memory controller may further include a memory arbiter to handle incoming memory requests. In the event of the memory controller receiving simultaneous requests, an attribute of the request may be used to determine which request is fulfilled or serviced first. A request may reflect a priority of the agent issuing said request, and said priority may determine when a request is fulfilled.

Systems utilizing Double Data Rate (DDR) memory may pipeline incoming requests to process them more efficiently. Pipelining requests requires a queue to store a specific number of requests. In the event of a full queue (i.e., the queue contains said number of requests), the requests stored in the queue must be processed before additional requests may be pipelined.

In these prior art memory controllers, a high priority request (i.e., a request issued from a high priority agent) may encounter an already full queue. This high priority request may have to wait until the queue finishes processing the entries stored in the queue. The requests in the queue may each be for large amounts of data, thus imposing a large latency on the high priority requests. This type of latency can greatly hinder system performance.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of a system utilizing an embodiment of the invention

FIG. 2 is a flow diagram of an embodiment of a process for memory request arbitration.

FIG. 3 is a block diagram of a memory interface utilizing an embodiment of the invention.

FIG. 4 illustrates example memory requests arbitrated within the embodiment illustrated in FIG. 3.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of the present invention relate to memory arbitration of agent requests for system memory. Embodiments of the present invention may help systems to meet latency requirements for real time traffic while optimizing data bandwidth efficiency in a multi-requestor system.

Example embodiments of the present invention describe logic or modules to function as a memory arbiter for managing agent requests for system memory. The memory arbiter may work in conjunction with (or be included in) a memory controller. Said memory controller may further work in conjunction with (or include) a queue to store agent requests for system memory. An outstanding byte count of the data requests by requests stored in the queue and priority information of a newly issued request may be used to optimize memory bandwidth utilization and guarantee a specific maximum latency for high priority requests.

Embodiments of the invention may be utilized, for example, by media processors. Media processors have particular challenges compared to CPU-centric systems with respect to memory bandwidth and latency requirements. Media processors have a large number of agents that consume a large fraction of the available bandwidth. This invention helps in meeting latency requirements for real time traffic while optimizing data bandwidth in a multi-requestor scenario.

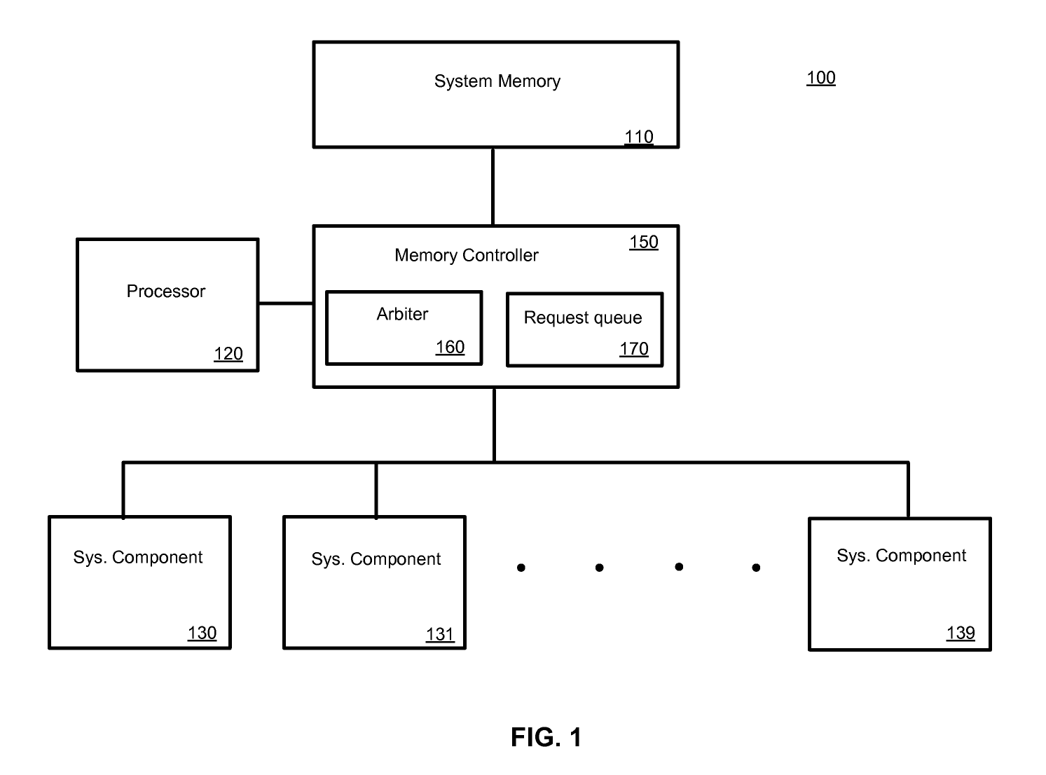

FIG. 1 is a block diagram of a system utilizing an embodiment of the invention. System 100 may be included in a desktop computer device, a mobile computer device, or any other any device utilizing a processor and system memory.

As shown in FIG. 1, system 100 may include system memory 110, processor 120, system components 130-139 and memory controller 150. System components 130-139 may comprise, for example, additional processors (e.g., graphics/display processors), processing logic or application modules. As described herein, processor 120 and system components 130-139 may be viewed generally as “agents” to memory controller 150. Systems utilizing embodiments of the invention may comprise any number or combination of agents.

One skilled in the art will recognize that system memory 110 may comprise various types of memory. For example, system memory 110 may comprise one or any combination of SDRAM (Synchronous DRAM) or RDRAM (RAMBUS DRAM) or DDR (Double Data Rate synchronous DRAM).

As used herein, a “memory request” is a transfer of command and address between an initiator (i.e., one of the agents) and system memory 110. Types of memory requests may include for example “read memory requests” to transfer of data from system memory 110 to the initiator, and “write memory requests” to write data from the initiator to a specific location of system memory 110.

Control information (including, e.g. the priority level and the read/write nature of the memory request) may be conveyed concurrent with the memory request or using a predefined protocol with respect to conveyance of the address.

Memory controller 150 further comprises memory arbiter 160 and request queue 170. Memory arbiter 160 will arbitrate multiple requests of variable data sizes issued by the system agents.

Memory controller 150 may manage memory requests to increase the efficiency of the use of memory 110. For example, if memory 110 comprises Data Double Rate (DDR) memory, requests may be pipelined in queue 170 prior to being serviced. Memory controller 150 may opportunistically look ahead and activate/precharge pages that need to be accessed via the requests stored in queue 170 (rather than waiting for a read/write request and then charging the needed page).

Prior art solutions for increasing the efficiency of DDR memory include arbitrating multiple requests and pipelining these requests to DDR memory by storing them in a request queue. These requests queue are of a fixed to store a specific number of requests. With these prior art pipelining mechanisms, a high priority request, upon encountering a full queue, may have to wait for all the requests in the current queue to drain out. This will add additional latency to the high priority request, especially if a significant number of the requests is the queue are requesting large amounts of data (e.g., requests typically issued in a media system). Embodiments of the present invention limit this latency that a high priority request may observe, while maintaining a highly efficient pipeline.

Embodiments of the invention may be described as utilizing an elastic pipeline to store arbitrated requests. The data size of the queued requests stored in queue 170 (i.e., the aggregate of the data requested by the requests stored in queue 170) may affect how memory arbitrator 160 will handle new requests. Thus, arbitration of memory requests received by system agents 120 and 130-139 is based, at least in part, on the number of data cycles outstanding at the time the new requests are received.

The (adjustable) limit for number of data cycles outstanding determines how many requests may be stored in queue 170, meaning the number of requests capable of being stored in queue 170 will vary throughout execution. In contrast, prior art solutions utilize a queue that stores a fixed number of outstanding requests. These prior art solutions fail to account for the potential of a large latency due to a high concentration of requests, each for a large amount of data.

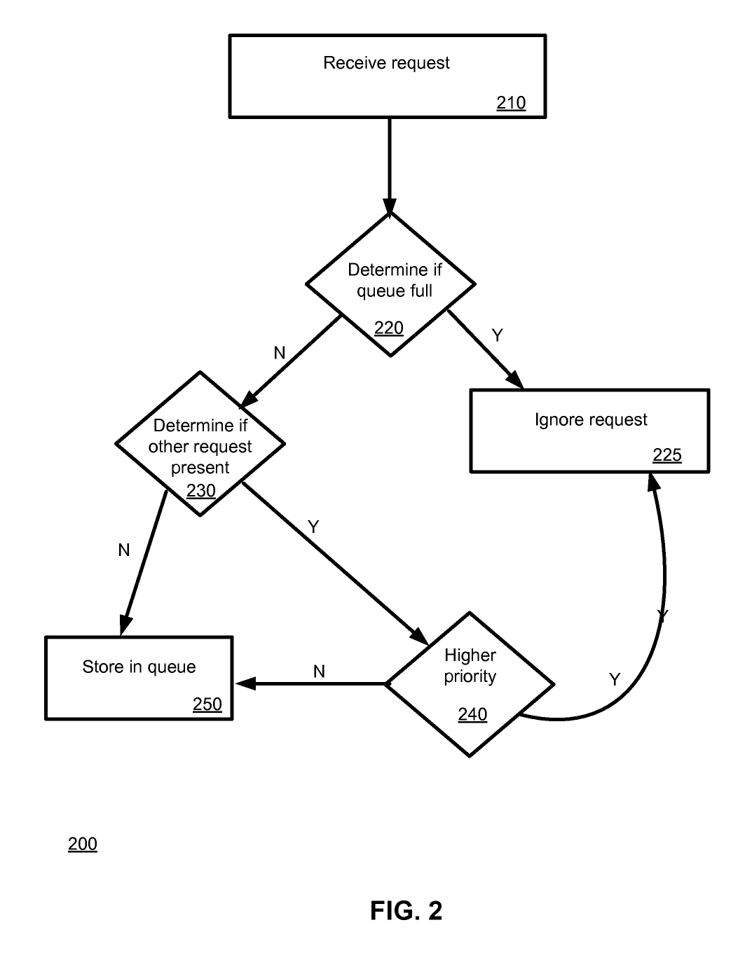

FIG. 2 is a flow diagram of an embodiment of a process for arbitrating memory requests from system agents. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 200 illustrates an example process for bounding the potential wait time for high priority agent requests for memory. In one embodiment, upon receipt of an agent request for system memory, 210, a determination is made as to whether a queue that stores agent requests is capable of storing said request, 220. The size of this queue may be dynamically adjusted such that attributes of requests to be stored, e.g., the length of the data requested, determine the number of entries that may be stored. For commands with short data lengths, the scheme permits a larger number of commands to be queued. For commands with long data lengths, the scheme may dictate that a smaller number of commands be queued.

As mentioned above, embodiments of the invention permit a DDR scheduler to opportunistically look ahead and activate/precharge pages that need to be accessed within a given window of time in the future. For commands with longer data lengths, fewer commands are queued as the longer data lengths associated with said commands ensure that the DDR scheduler may achieve the same efficiency without needing to inspect a large number of commands. In both cases, limiting the number of data cycles ensures that there is a limit to the number of cycles a high priority request needs to wait due to head of line blocking.

If the request cannot be stored in the queue, the request is not serviced, 225. If the queue is not full (i.e., the amount of data requested by requests stored in the queue is below a certain threshold), a determination is made whether another agent request for system memory was received, 230. If there are no other requests present, then the request may be stored in the queue for subsequent pipeline processing, 250.

If there is another request present, an arbitration scheme may be implemented to determine which entry to store in the queue first. In one embodiment, the arbitration is based on the priority of each system memory request, 240. A priority can be assigned to each agent, and when two or more agents make simultaneous requests, the higher-priority agent is chosen to access the resource while the lower-priority agent is delayed. Such priority-based arbitration maximizes performance of higher-priority agents at the expense of lower-priority agents. In a typical implementation, the priorities are fixed in the arbiter per the requesting agent. Some agents may have multiple priority levels.

Thus, if there is no other request pending that has a higher priority, said memory request is stored in the queue, 250. If there is another pending request of higher priority, then that request is stored in the queue, and said request may ignored and may further require the respective agent to reissue the request in order to subject it to process 200 again (i.e., determining if there is room in the queue to store said request, determining if another request of a high priority was received, etc.).

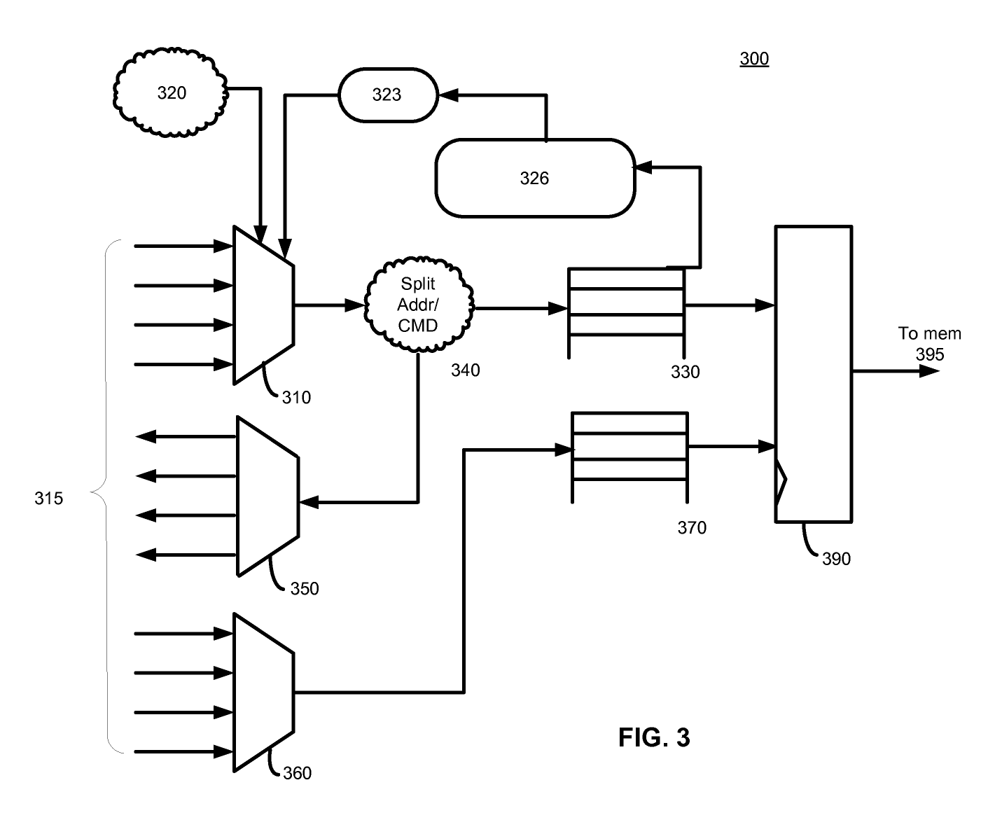

FIG. 3 illustrates an embodiment of a memory interface utilizing an embodiment of the invention. System 300 includes agent select logic 310 to select which commands (e.g., memory requests) from agents 315 will be serviced. Agents select logic 310 may determine which agent command to select based on arbitration logic 320 and queue level logic 323. In one embodiment, arbitration logic 320 compares the priority level of each of the commands from agents 315, wherein higher priority requests are given preference over lower priority requests. Queue level logic 323 may receive information byte count level logic 326 indicating whether the outstanding byte level count within elastic command queue 330 is currently greater than or equal to a programmable threshold. The “outstanding byte level count” refers to the amount of memory requested by the commands currently stored in data queue 330.

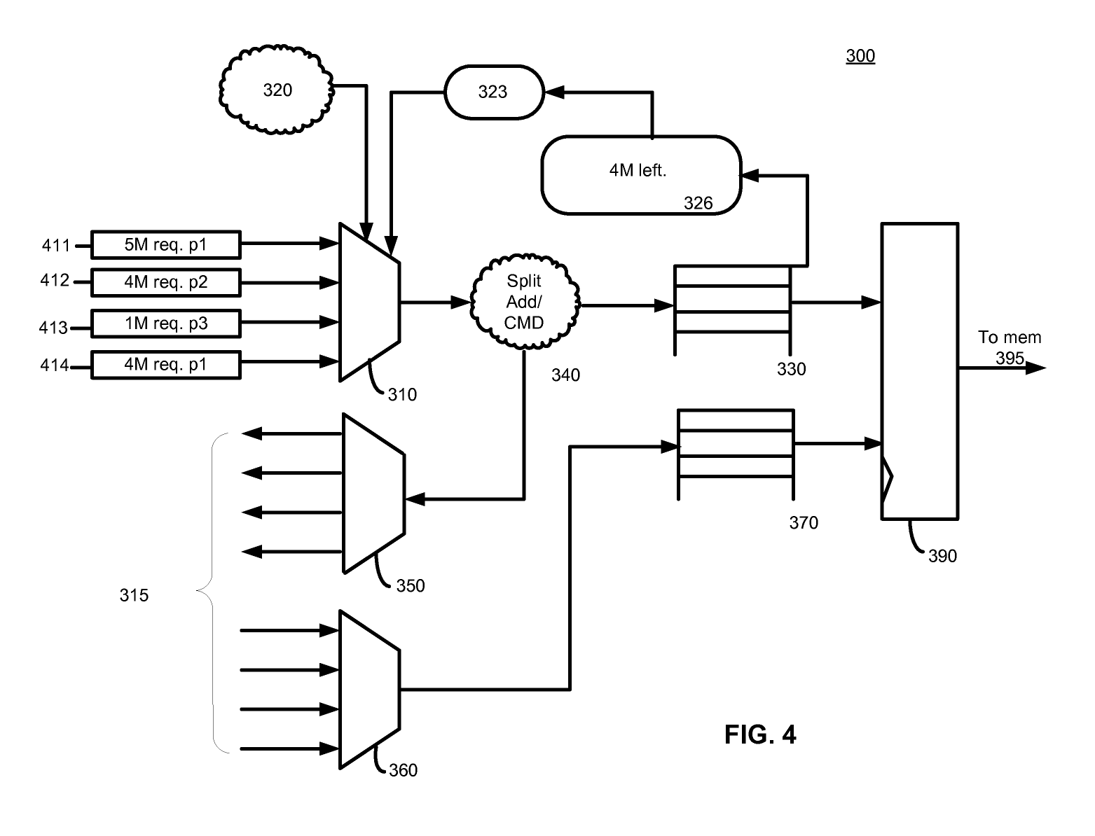

If byte count level logic 326 determines that the outstanding byte level count within elastic command queue 330 is currently greater than or equal to the programmable threshold, then none of commands from agents 315 will be serviced. If the outstanding byte level count within elastic command queue 330 is less than the programmable threshold, then the command from agents 315 with the highest priority level may be selected (scenarios where said command may still not be selected are discussed with respect to FIG. 4).

The selected agent command and the address of the memory to be serviced by the command are split into different execution paths via logic 340. The selected agent command is stored in command queue 330. In one embodiment, command queue 330 comprises a first-in-first-out (FIFO) queue. The address of the memory to be serviced is directed back to the corresponding agent (via port data fetch logic 350 coupled to agents 315) and said memory is returned from the correct agent (via data fetch select logic 360 coupled to agents 315). For example, the selected agent command may be a write command, and the data the agent wishes to write to memory may be retrieved and stored in data queue 370. In one embodiment, data queue 370 is a FIFO queue with entries corresponding to elastic command queue 330.

Memory backend processing 390 may “precharge” or execute other preprocessing operations to the corresponding pages of memory included in memory 395 based on the commands stored in request queue 330.

FIG. 4 illustrates example memory requests within the embodiment illustrated in FIG. 3. In this example, four agent memory requests arrive simultaneously at agent select logic 310. Request 411 may comprise a request for 5 memory units (e.g., megabytes) with a priority level of 1 (the highest priority). Request 412 may comprise a request for 4 memory units with a priority level of 2 (the second highest priority). Request 413 may comprise a request of 1 memory unit with a priority level of 4. Request 414 may comprise a request of 4 memory units with a priority level of 1. It is to be understood that requests 411-414 may be issued from any number/combination of agents 315.

Byte count level logic 326 may determine that outstanding byte request level is less than 4 memory units of the programmable threshold—i.e., memory requests of 4 memory units or less may be serviced. In the above example, request 414 may be selected to be serviced based on its priority level and the size of the memory that is being requested.

In another example, wherein only requests 411-413 arrive simultaneously, no requests are selected to be serviced to ensure request 411, which has the highest priority of requests 411-413, has the lowest latency possible before it is serviced. In one embodiment, all of the commands stored in elastic command queue 330 are serviced when the above condition is encountered. In another embodiment, the outstanding byte level request is checked after at least one command stored in elastic command queue 330 is serviced in order to determine if it is possible for request 411 to be serviced.

Various components referred to above as processes, servers, or tools described herein may be a means for performing the functions described. Each component described herein includes software or hardware, or a combination of these. The components can be implemented as software modules, hardware modules, special-purpose hardware (e.g., application specific hardware, ASICs, DSPs, etc.), embedded controllers, hardwired circuitry, etc. Software content (e.g., data, instructions, configuration) may be provided via an article of manufacture including a computer storage readable medium, which provides content that represents instructions that can be executed. The content may result in a computer performing various functions/operations described herein. A computer readable storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable storage medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

What is claimed is:

1. A system comprising:
a plurality of agents;
a memory accessible to the plurality of agents, each agent to access the memory via a memory request issued by the agent, the memory request to indicate a priority level of the memory request and a size of the memory to be accessed;
a queue to receive and store a number of issued memory requests;
arbitration logic, coupled to the plurality of agents and the queue, to receive memory requests and to determine which requests to send to the queue based, at least in part, on the priority of each request, the size of the memory to be accessed by each memory request, and a configurable byte threshold assigned to the queue; and
memory processing logic, coupled to the queue and the memory, to process the memory requests stored in the queue.

2. The system of claim 1, wherein determining, via the arbitration logic, which requests to send to the queue is further based on whether the sum of the sizes of memory to be accessed by each of the memory requests to be stored in the queue is less than the configurable byte threshold assigned to the queue.

3. The system of claim 1, wherein the memory comprises DDR memory.

4. The system of claim 3, wherein processing the memory requests stored in the queue includes, for each of the memory requests,
precharging a memory bank that includes the memory to be accessed, and
activating memory pages included in the memory to be accessed.

5. The system of claim 1, wherein the priority level of each memory request is based, at least in part, on a memory latency requirement of the agent issuing the request.

6. The system of claim 1, wherein the queue comprises a first-in-first-out (FIFO) queue.

7. The system of claim 1, wherein the size of the queue is configurable.

8. A method comprising:
receiving a plurality of memory requests issued by at least one agent, each memory request to indicate a priority level of the memory request and a size of the memory to be accessed from a system memory;
determining which of the plurality of requests to store in a queue based, at least in part, on the priority of each request, the size of the memory to be accessed by each memory request and a programmable byte threshold assigned to the queue; and
processing the memory requests stored in the queue.

9. The method of claim 8, wherein determining which of the plurality of requests to store in the queue is further based on whether the sum of the sizes of memory to be accessed by each of the memory requests to be stored in the queue is less than the configurable byte threshold assigned to the queue.

10. The method of claim 8, wherein the system memory comprises DDR memory.

11. The method of claim 10, wherein processing the memory requests stored in the queue includes, for each of the memory requests,
precharging a memory bank that includes the memory to be accessed, and
activating memory pages included in the memory to be accessed.

12. The method of claim 8, wherein the priority level of each memory request is based, at least in part, on a memory latency requirement of the agent issuing the request.

13. The method of claim 8, wherein the queue comprises a first-in-first-out (FIFO) queue.

14. The method of claim 8, wherein the size of the queue is configurable.

15-20. (canceled)

21. A media processor comprising:
a plurality of agents to access a memory, each agent to access the memory via a memory request issued by the agent, the memory request to indicate a priority level of the memory request and a size of the memory to be accessed;
a queue to receive and store a number of issued memory requests; and
arbitration logic, coupled to the plurality of agents and the queue, to receive memory requests and to determine which requests to send to the queue based, at least in part, on the priority of each request, the size of the memory to be accessed by each memory request, and a configurable byte threshold assigned to the queue.

22. The media processor of claim 21, wherein determining which of the plurality of requests to store in the queue is further based on whether the sum of the sizes of memory to be accessed by each of the memory requests to be stored in the queue is less than the configurable byte threshold assigned to the queue.

23. The media processor of claim 21, wherein the system memory comprises DDR memory.

24. The media processor of claim 21, wherein the priority level of each memory request is based, at least in part, on a memory latency requirement of the agent issuing the request.

25. The media processor of claim 21, wherein the queue comprises a configurable first-in-first-out (FIFO) queue.
